(19) United States
(12) Patent Application Publication
(10) Pub. No.: US 2018/0347864 A1
(43) Pub. Date: Dec. 6, 2018

(54) NATURAL REFRIGERANT TRANSPORT REFRIGERATION UNIT

(71) Applicant: Carrier Corporation, Farmington, CT (US)

(72) Inventors: Robert A. Chopko, Baldwinsville, NY (US); Yu H. Chen, Manlius, NY (US); Greg Deldicque, Fayetteville, NY (US)

(73) Assignee: Carrier Corporation, Farmington, CT (US)

(21) Appl. No.: 15/781,178

(22) PCT Filed: Nov. 30, 2016
(86) PCT No.: PCT/US2016/064073

§ 371 Date: Jun. 4, 2018

Related U.S. Application Data
(60) Provisional application No. 62/263,133, filed on Dec. 4, 2015.

(51) Int. Cl. F25B 9/00; B60H 1/00; B60H 1/32; F25B 1/04; F25B 40/02; F25D 29/00

(52) U.S. Cl. CPC F25B 9/008; B60H 1/00364; B60H 1/00385; B60H 1/3223; B60H 1/3232; F25B 2600/112; F25B 40/02; F25D 29/003; F25B 2400/0409; F25B 2600/111; F25B 1/04

(57) ABSTRACT

A transport refrigeration unit that may be applied to a tractor trailer system includes a compressor constructed and arranged to compress a natural refrigerant, a condenser heat exchanger operatively coupled to the compressor, and an evaporator heat exchanger operatively coupled to the compressor. A power supply of the unit is electrically coupled to an electric compressor motor that drives the compressor, an electric condenser fan motor that drives a condenser fan and an electric evaporator fan motor that drives an evaporator fan.

### BACKGROUND

The present disclosure relates to transport refrigeration units and, more particularly, to transport refrigeration units utilizing natural refrigerants.

Traditional refrigerated cargo trucks or refrigerated tractor trailers, such as those utilized to transport cargo via sea, rail, or road, is a truck, trailer or cargo container, generally defining a cargo compartment, and modified to include a refrigeration system located at one end of the truck, trailer, or cargo container. Refrigeration systems typically include a compressor, a condenser, an expansion valve, and an evaporator serially connected by refrigerant lines in a closed refrigerant circuit in accord with known refrigerant vapor compression cycles. A power unit, such as a combustion engine, drives the compressor of the refrigeration unit, and may be diesel powered, natural gas powered, or other type of engine. In many tractor trailer transport refrigeration systems, the compressor is driven by the engine shaft either through a belt drive or by a mechanical shaft-to-shaft link. In other systems, the engine drives a generator that generates electrical power, which in-turn drives the compressor.

With current environmental trends, improvements in transport refrigeration units is desirable particularly toward aspects of environmental impact. With environmentally friendly refrigeration units, improvements in reliability, and cost and weight reduction is also desirable.

### SUMMARY

A transport refrigeration unit according to one, non-limiting, embodiment of the present disclosure includes a compressor constructed and arranged to compress a natural refrigerant; an electric compressor motor configured to drive the compressor; a condenser heat exchanger operatively coupled to the compressor; a condenser fan configured to provide air flow over the condenser heat exchanger; an electric condenser fan motor for driving the condenser fan; an evaporator heat exchanger operatively coupled to the compressor; an evaporator fan configured to provide air flow over the evaporator heat exchanger; an electric evaporator fan motor for driving the evaporator fan; and a power supply coupled to the electric compressor motor, the electric condenser fan motor and the electric evaporator fan motor to selectively provide electrical power to the motors.

Additionally to the foregoing embodiment, the compressor is a two-stage compressor.

In the alternative or additionally thereto, in the foregoing embodiment, the compressor is a scroll-type compressor.

In the alternative or additionally thereto, in the foregoing embodiment, the power supply is a fuel cell.

In the alternative or additionally thereto, in the foregoing embodiment, the power supply is an electric generator driven by a combustion engine.

In the alternative or additionally thereto, in the foregoing embodiment, the combustion engine is a diesel engine.

In the alternative or additionally thereto, in the foregoing embodiment, the transport refrigeration unit includes a natural refrigerant bypass configured to receive a portion of the natural refrigerant flowing between the condenser and the evaporator, bypassing the portion around the evaporator, and flowing the portion to the compressor.

In the alternative or additionally thereto, in the foregoing embodiment, the transport refrigeration unit includes a natural refrigerant bypass configured to receive a portion of the natural refrigerant flowing between the condenser and the evaporator, bypassing the portion around the evaporator, and flowing the portion to the compressor.

In the alternative or additionally thereto, in the foregoing embodiment, the natural refrigerant comprises CO2.

A tractor trailer system according to another, non-limiting, embodiment includes a self-propelled tractor; a transport trailer adapted to be connected and towed by the self-propelled tractor, the transport trailer including a front wall, and wherein the connected transport trailer and the tractor define a predetermined envelope bounded by a tractor swing radius and the front wall; and a transport refrigeration unit mounted on the front wall and disposed within the predetermined envelope, the transport refrigeration unit including a compressor configured to compress natural refrigerant and having a discharge port and a suction port, a compressor motor configured to drive the compressor, a condenser heat exchanger operatively coupled to the compressor discharge port, a condenser fan configured to flow air over the condenser heat exchanger, a condenser fan motor configured to drive the condenser fan, an evaporator heat exchanger operatively coupled to the compressor suction port; an evaporator fan configured to flow air over the evaporator heat exchanger, an evaporator fan motor configured to drive the evaporator fan, a power source configured to selectively provide electric power to the motors, a structural support framework configured to be attached to the front wall, an outer cover supported by the framework and disposed within the pre-determined envelope, and wherein the compressor, the compressor motor, the condenser heat exchanger, the condenser fan, the condenser fan motor, the evaporator heat exchanger, the evaporator fan, the evaporator fan motor and the power source are supported by the structural support framework and contained within the outer cover.

Additionally to the foregoing embodiment, the natural refrigerant is CO2.

In the alternative or additionally thereto, in the foregoing embodiment, the power source is an integrally mounted unitary engine driven generator assembly configured to selectively produce at least one A.C. voltage at one or more frequencies.

In the alternative or additionally thereto, in the foregoing embodiment, the generator assembly comprises a synchronous generator.

In the alternative or additionally thereto, in the foregoing embodiment, the generator assembly comprises a non-synchronous generator.

In the alternative or additionally thereto, in the foregoing embodiment, the compressor is a two-stage compressor.

In the alternative or additionally thereto, in the foregoing embodiment, the compressor is a scroll-type compressor.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a perspective view of a tractor trailer system having a transport refrigeration unit as one, non-limiting, exemplary embodiment of the present disclosure;

FIG. 2 is a perspective view of a transport refrigeration unit of the tractor trailer system;

FIG. 3 is a partial top view of the tractor trailer system;

FIG. 4 is front view of the transport refrigeration unit with a cover removed to show internal detail; and

FIG. 5 is a schematic of the refrigerant vapor compression cycle of the transport refrigeration unit.

### DETAILED DESCRIPTION

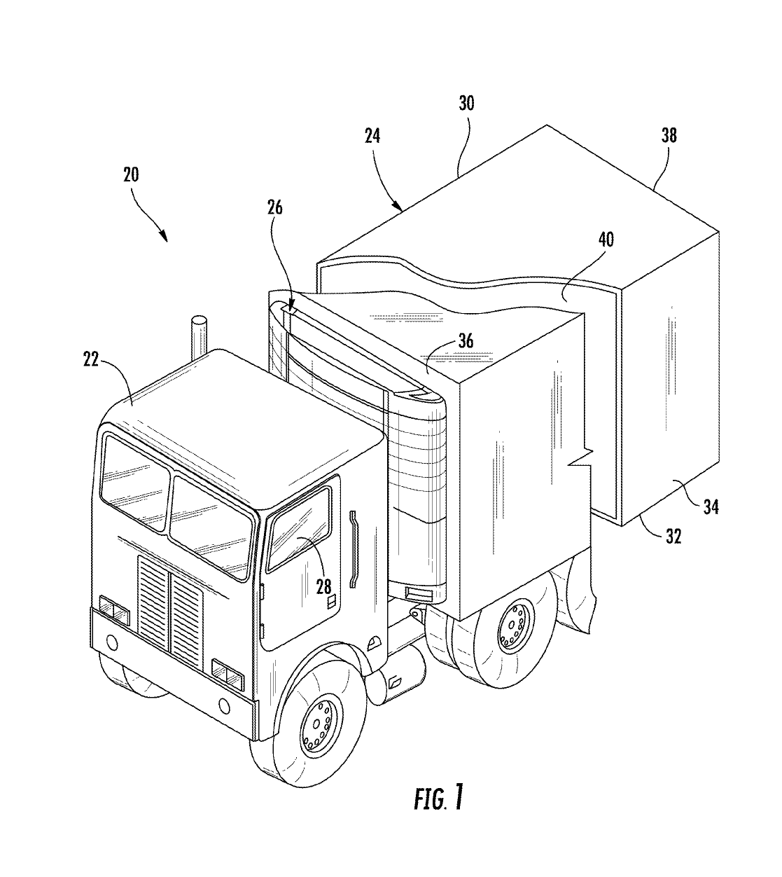

Referring to FIG. 1, a tractor trailer system 20 of the present disclosure is illustrated. The tractor trailer system 20 may include a tractor or truck 22, a trailer 24 and a transport refrigeration unit 26. The tractor 22 may include an operator's compartment or cab 28 and an engine (not shown) which is part of the powertrain or drive system of the tractor 22. The trailer 24 may be coupled to the tractor 22 and is thus pulled or propelled to desired destinations. The trailer may include a top wall 30, a bottom wall 32 opposed to and space from the top wall 30, two side walls 34 space from and opposed to one-another, and opposing front and rear walls 36, 38 with the front wall 36 being closest to the tractor 22. The trailer 24 may further include doors (not shown) at the rear wall 38, or any other wall. The walls 30, 32, 34, 36, 38 together define the boundaries of a cargo compartment 40.

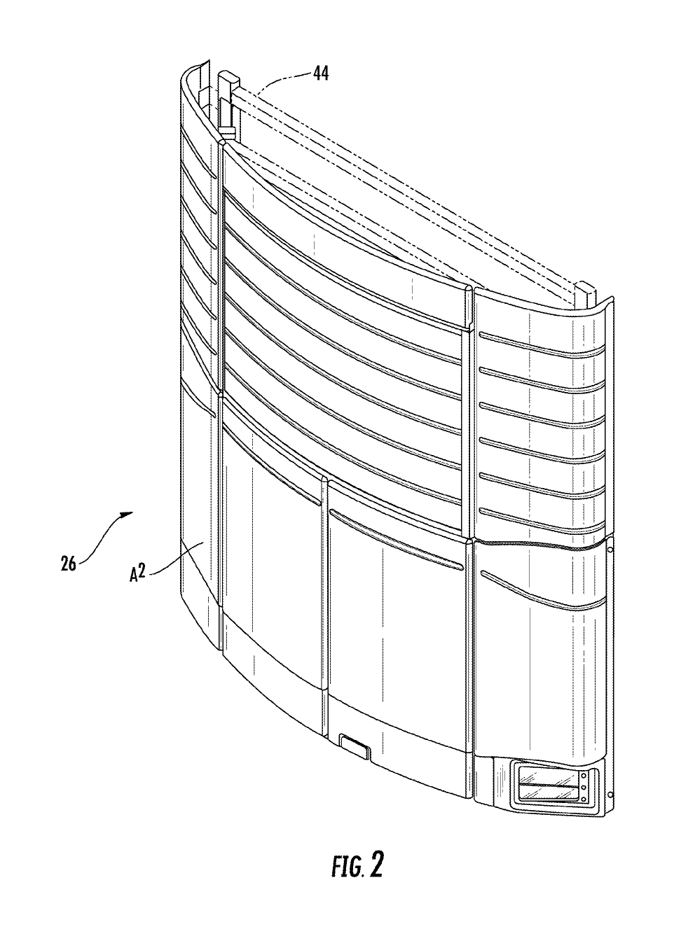

Referring to FIGS. 1 and 2, the trailer 24 is generally constructed to store a cargo (not shown) in the compartment 40. The refrigeration unit 26 is generally integrated into the trailer 24 and may be mounted to the front wall 36. The cargo is maintained at a desired temperature by cooling of the compartment 40 via the refrigeration unit 26 that circulates airflow into and through the cargo compartment 40 of the trailer 24. It is further contemplated and understood that the refrigeration unit 26 may be applied to any transport compartments (e.g. shipping containers) and not necessarily those used in tractor trailer systems.

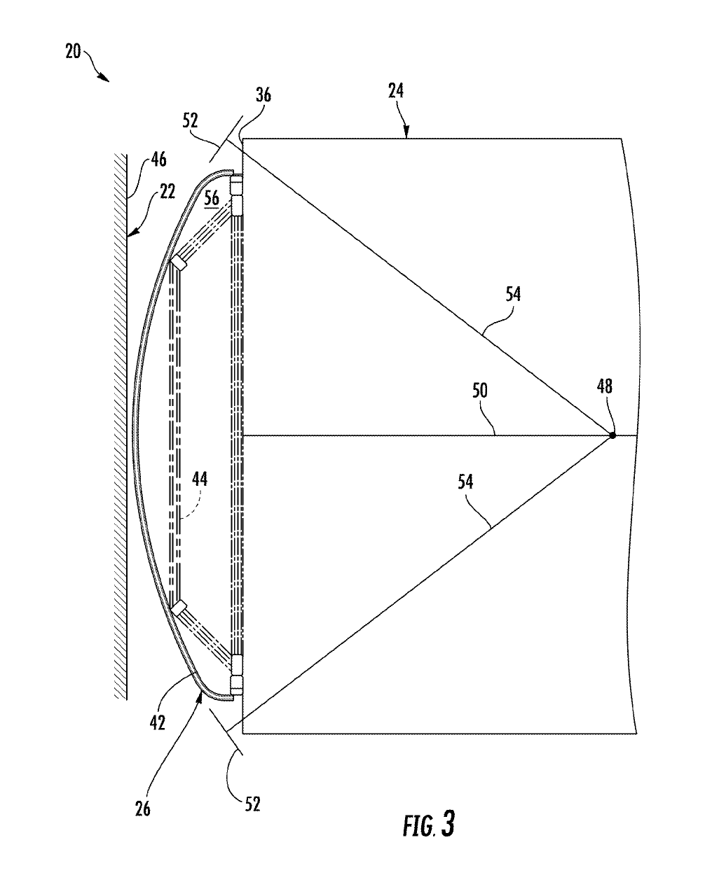

Referring to FIGS. 2 and 3, the transport refrigeration unit 26 may include an outer cover 42 and a structural framework 44. All of the internal components of the transport refrigeration unit 26 may be supported by the framework 44 and disposed behind or within the cover 42. The outer cover 42 may also be structurally supported by the structural framework 44. As is common for transport refrigeration units, various panels of the outer cover 42 may be hinged and are removable to provide ready access to the refrigeration system for the performance of routine maintenance.

The relatively thin profile or depth of the refrigeration unit 26 allows the distance between a back 46 of the tractor 22 and the front wall 36 of the trailer 24 to be relatively small while still accommodating the a turning radius of the tractor trailer combination (i.e., the tractor trailer system 20). A point 48 located along a centerline 50 of the trailer 24 represents the attachment/pivot point of the tractor 22 to the trailer 24. An arcuate line 52 extends between radius lines 54, and represents the swing radius of the back 46 of the tractor 22 during the full range of turning capability of the tractor. The profile of the refrigeration unit 26, as defined by the outer cover 42, allows the relatively close spacing between the back 46 of the tractor 22 and the front wall 36 of the trailer 24 while allowing clearance between the back 46 and the refrigeration unit 26 and its outer cover 42. In general, the connected transport trailer 24 and the tractor 22 define a predetermined envelope 56 bounded by the tractor swing radius and the front wall 36 of the trailer 24.

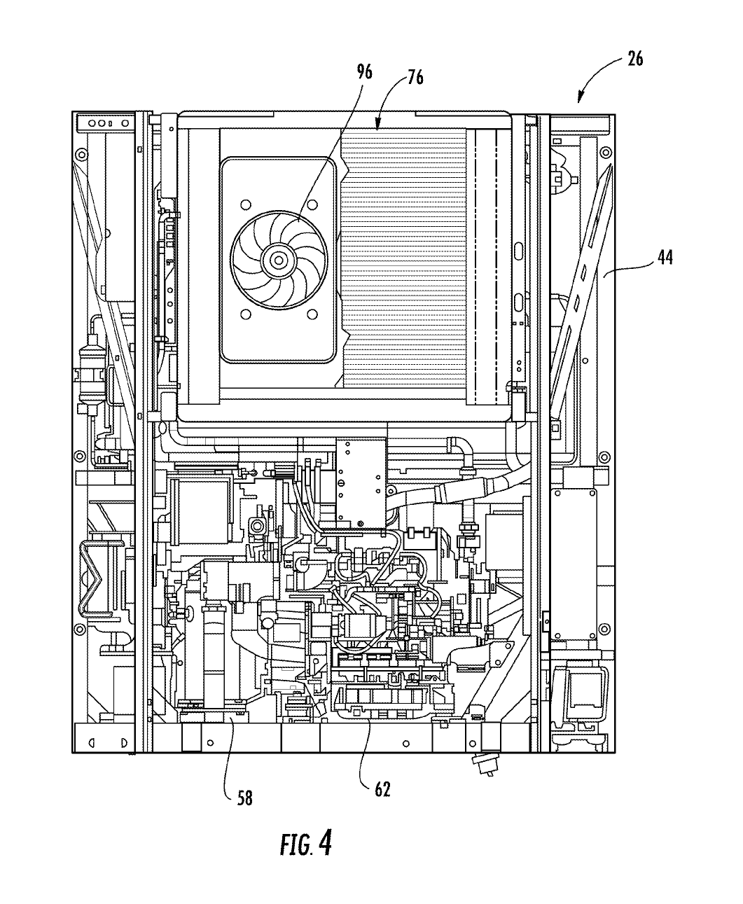

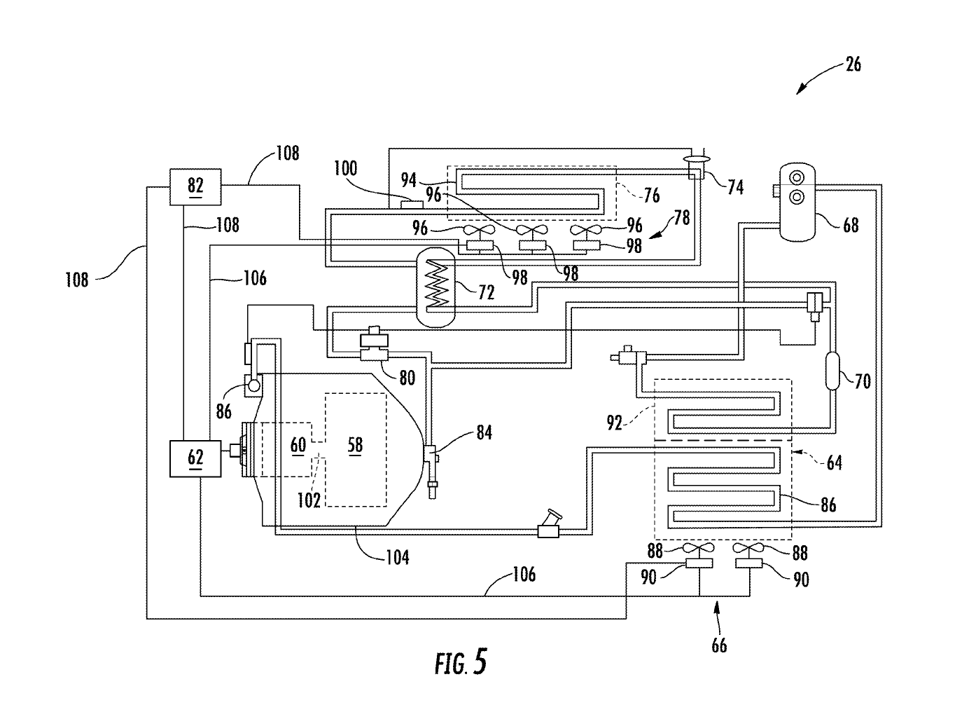

Referring to FIGS. 4 and 5, the components of the transport refrigeration unit 26 may include a compressor 58, an electric compressor motor 60, a power source 62, a condenser 64 that may be air cooled, a condenser fan assembly 66, a receiver 68, a filter dryer 70, a heat exchanger 72, a thermostatic expansion valve 74, an evaporator 76, an evaporator fan assembly 78, a suction modulation valve 80, and a controller 82 that may include a microprocessor. Operation of the transport refrigeration unit 26 may best be understood by starting at the compressor 58, where the suction gas (i.e., natural refrigerant) enters the compressor at a suction port 84 and is compressed to a higher temperature and pressure. The refrigerant gas is emitted from the compressor at an outlet port 86 and may then flow into tube(s) 86 of the condenser 64.

Air flowing across a plurality of condenser coil fins (not shown) and the tubes 86 cools the gas to its saturation temperature. The air flow across the condenser 64 may be facilitated by one or more fans 88 of the condenser fan assembly 66. The condenser fans 88 may be driven by respective condenser fan motors 90 that may be electric.

By removing latent heat, the gas within the tubes 86 condenses to a high pressure and high temperature liquid and flows to the receiver 68 that provides storage for excess liquid refrigerant during low temperature operation. From the receiver 68, the liquid refrigerant may pass through a subcooler heat exchanger 92 of the condenser 64, through the filter-dryer 70 that keeps the refrigerant clean and dry, then to the heat exchanger 72 that increases the refrigerant subcooling, and finally to the thermostatic expansion valve 74.

As the liquid refrigerant passes through the orifices of the expansion valve 74, some of the liquid vaporizes into a gas (i.e., flash gas). Return air from the refrigerated space (i.e., cargo compartment 40) flows over the heat transfer surface of the evaporator 76. As the refrigerant flows through a plurality of tubes 94 of the evaporator 76, the remaining liquid refrigerant absorbs heat from the return air, and in so doing, is vaporized.

The air flow across the evaporator 76 is facilitated by one or more evaporator fans 96 that may be driven by respective fan motors 98 that may be electric. From the evaporator 76, the refrigerant in vapor form may then flow through the suction modulation valve 80, and back to the compressor 58. A thermostatic expansion valve bulb sensor 100 may be located on the evaporator outlet tube 94. The bulb sensor 100 is intended to control the thermostatic expansion valve 74, thereby controlling refrigerant superheat at the evaporator outlet tube 94. It is further contemplated and understood that the above generally describes a single stage vapor compression system that may be used for natural refrigerants such as propane and ammonia. Other refrigerant systems may also be applied that use carbon dioxide (CO2) refrigerant, and that may be a two-stage vapor compression system.

A bypass valve (not shown) may facilitate the flash gas of the refrigerant to bypass the evaporator 76. This will allow the evaporator coil to be filled with liquid and completely ‘wetted’ to improve heat transfer efficiency. With CO2 refrigerant, this bypass flash gas may be re-introduced into a mid-stage of a two-stage compressor.

The compressor 58 and the compressor motor 60 may be linked via an interconnecting drive shaft 102. The compressor 58, the compressor motor 60 and the drive shaft 102 may all be sealed within a common housing 104. The compressor 58 may be a single compressor. The single compressor may be a two-stage compressor, a scroll-type compressor or other compressors adapted to compress natural refrigerants. The natural refrigerant may be CO2, propane, ammonia, or any other natural refrigerant that may include a global-warming potential (GWP) of about one (1).

The power source 62 may be configured to selectively power the compressor motor 60, the condenser fan motors 90, and the evaporator fan motors 98 via electrical conductors 106. The controller 82 through a series of data and command signals over various pathways 106 may control the electric motors 60, 90, 98 as dictated by the cooling needs of the refrigeration unit 26. In one embodiment, the power source may include an electric generator driven by an independent combustion engine that may be a diesel engine. In another embodiment, the power source 62 may be fuel cells, batteries, or a combination of both. In yet another embodiment, the power source 62 may include a synchronous or non-synchronous permanent magnet generator adapted to fully power the various electric components of the refrigeration unit 20 and at varying predetermined controlled system output frequencies that may be regulated by the controller 82.

Benefits of the present disclosure include an environmentally friendly refrigeration unit that meets the confined space requirements of a tractor trailer system. Moreover, the use of the single compressor improves system reliability, cost, weight and operating efficiency.

While the present disclosure is described with reference to exemplary embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. A transport refrigeration unit comprising:
a compressor constructed and arranged to compress a natural refrigerant;
an electric compressor motor configured to drive the compressor;
a condenser heat exchanger operatively coupled to the compressor;
a condenser fan configured to provide air flow over the condenser heat exchanger;
an electric condenser fan motor for driving the condenser fan;
an evaporator heat exchanger operatively coupled to the compressor;
an evaporator fan configured to provide air flow over the evaporator heat exchanger;
an electric evaporator fan motor for driving the evaporator fan; and
a power supply coupled to the electric compressor motor, the electric condenser fan motor and the electric evaporator fan motor to selectively provide electrical power to the motors.

2. The transport refrigeration unit set forth in claim 1, wherein the compressor is a two-stage compressor.

3. The transport refrigeration unit set forth in claim 1, wherein the compressor is a scroll-type compressor.

4. The transport refrigeration unit set forth in claim 1, wherein the power supply is a fuel cell.

5. The transport refrigeration unit set forth in claim 1, wherein the power supply is an electric generator driven by a combustion engine.

6. The transport refrigeration unit set forth in claim 5, wherein the combustion engine is a diesel engine.

7. The transport refrigeration unit set forth in claim 1 further comprising:
a natural refrigerant bypass configured to receive a portion of the natural refrigerant flowing between the condenser and the evaporator, bypassing the portion around the evaporator, and flowing the portion to the compressor.

8. The transport refrigeration unit set forth in claim 2 further comprising:
a natural refrigerant bypass configured to receive a portion of the natural refrigerant flowing between the condenser and the evaporator, bypassing the portion around the evaporator, and flowing the portion to the compressor.

9. The transport refrigeration unit set forth in claim 1, wherein the natural refrigerant comprises CO2.

10. A tractor trailer system comprising:
a self-propelled tractor;
a transport trailer adapted to be connected and towed by the self-propelled tractor, the transport trailer including a front wall, and wherein the connected transport trailer and the tractor define a predetermined envelope bounded by a tractor swing radius and the front wall; and
a transport refrigeration unit mounted on the front wall and disposed within the predetermined envelope, the transport refrigeration unit including a compressor configured to compress natural refrigerant and having a discharge port and a suction port, a compressor motor configured to drive the compressor, a condenser heat exchanger operatively coupled to the compressor discharge port, a condenser fan configured to flow air over the condenser heat exchanger, a condenser fan motor configured to drive the condenser fan, an evaporator heat exchanger operatively coupled to the compressor suction port; an evaporator fan configured to flow air over the evaporator heat exchanger, an evaporator fan motor configured to drive the evaporator fan, a power source configured to selectively provide electric power to the motors, a structural support framework configured to be attached to the front wall, an outer cover supported by the framework and disposed within the pre-determined envelope, and wherein the compressor, the compressor motor, the condenser heat exchanger, the condenser fan, the condenser fan motor, the evaporator heat exchanger, the evaporator fan, the evaporator fan motor and the power source are supported by the structural support framework and contained within the outer cover.

11. The tractor trailer system set forth in claim 10, wherein the natural refrigerant is CO2.

12. The tractor trailer system set forth in claim 11, wherein the power source is an integrally mounted unitary engine driven generator assembly configured to selectively produce at least one A.C. voltage at one or more frequencies.

13. The tractor trailer system set forth in claim 12, wherein the generator assembly comprises a synchronous generator.

14. The tractor trailer system set forth in claim 12, wherein the generator assembly comprises a non-synchronous generator.

15. The tractor trailer system set forth in claim 10, wherein the compressor is a two-stage compressor.

16. The tractor trailer system set forth in claim 10, wherein the compressor is a scroll-type compressor.
